(19) United States
(12) Patent Application Publication
(10) Pub. No.: US 2026/0231874 A1
(43) Pub. Date: Aug. 13, 2026

(54) VACUUM CONTROL SYSTEM FOR SAP FLOW OPTIMIZATION, AND METHOD OF CONTROLLING PRESSURE WITHIN A CONDUIT NETWORK OF A SAP COLLECTION SYSTEM

(71) Applicant: LES ÉQUIPEMENTS LAPIERRE INC., Saint-Ludger (CA)

(72) Inventors: Stéphane GUAY, Saint-Ludger (CA); Marc-André VERVILLE, Saint-Ludger (CA); Carl LAPIERRE, Saint-Ludger (CA)

(21) Appl. No.: 19/532,237

(22) Filed: Feb. 6, 2026

Related U.S. Application Data
(60) Provisional application No. 63/755,496, filed on Feb. 7, 2025.

(51) Int. Cl. A01G 23/10; F04B 19/04; F04B 37/14; F04B 49/06

(52) U.S. Cl. CPC A01G 23/10; F04B 49/065; F04B 19/04; F04B 37/14; F04B 2205/06; F04B 2205/171; F04B 2207/02; F04B 2207/03

(57) ABSTRACT

A vacuum control system for a sap collection system having a conduit network coupled to a plurality of trees and a vacuum pump operatively connectable to the conduit network to control a pressure in the conduit network is provided. The vacuum control system can comprise a reference pressure sensor coupled to a reference tree, the reference pressure sensor being configured to measure a pressure within a vascular system of the reference tree, and a controller communicatively coupled to the pressure sensor and configured to control a flow rate of the vacuum pump in response to pressure data received from the pressure sensor to vary a pressure in the conduit network of the sap collection system.

### CROSS-REFERENCE TO RELATED APPLICATIONS

The present application claims priority from U.S. provisional patent application no. 63/755,496, filed on Feb. 7, 2025, and entitled “VACUUM CONTROL SYSTEM FOR SAP FLOW OPTIMIZATION, AND CORRESPONDING METHODS OF ASSEMBLING, OPERATING AND USE ASSOCIATED THERETO”, the disclosures of which are hereby incorporated by reference in their entireties.

### TECHNICAL FIELD

The present disclosure relates to the production of syrups, including maple syrup. More particularly, it concerns systems and methods for controlling, including selectively varying, vacuum levels in one or more closed fluid circuits of sap collection systems.

### BACKGROUND

A sap collection system is generally distributed over a large surface area of a sap tree forest, for the collection of sap. It is known that when the sap is sufficiently boiled, its sugar content concentrates thereby producing syrup. In situations where the sap trees are maple trees, the sap is referred to as “maple water,” and the syrup is referred to as “maple syrup.”

The typical vacuum-based sap collection system includes a vacuum pump, a main collection tube having a larger diameter (e.g., 2 inches) fluidly connected to the vacuum pump, and a certain number of auxiliary collection tubes of smaller diameter (e.g., 3/16^{th} or 5/16^{th} of an inch) fluidly connected to the main collection tubes at different locations thereof. The conduit network formed by the main collection tube and the auxiliary collection tubes extend across the sap tree forest, the details of which depend on the actual sap tree forest and geographical terrain. The sap collection system is provided with sap collection taps fluidly connecting the sap trees to corresponding auxiliary collection tubes at different locations thereof. At a given period of the year, sap flows from the sap trees, into the auxiliary tubes via the sap collection taps, and into the main collection tube and ultimately to a main reservoir. The sap is drawn into the conduit network in part due to the vacuum created by the vacuum pump which draws the sap along the conduit network, and to gravity as the conduit network preferably has a generally downward slope leading to the main reservoir.

The sap flow of a maple tree is moreover heavily weather-dependent, with temperature fluctuations creating pressure within a vascular system of a tree (e.g., the xylem) to move the sap. Specifically, ambient temperatures must fall below freezing (typically at night) and rise above freezing (typically during the day), for sap to flow. During a cooling event, the gasses in the aerial part (or the branches) of the tree contract thereby lower an internal pressure of the tree. In turn, the lower pressure draws water up from the roots. When a warm day follows, higher pressure develops in the xylem of the tree, forcing sap through the xylem and out the taphole or wound.

Traditional sap collection systems utilize vacuum pumps which operate at full capacity to extract a maximum quantity of sap during the sap harvesting season. Moreover, many producers choose to leave their pumps on at all times regardless of the state of the trees and the corresponding pressure within their respective vascular system. However, the extraction of sap in this manner presents several downsides. When the pressure inside the tree is low (e.g., during cold nights when the sap flow naturally slows), extracting sap could cause excessive stress to the tree. If sap is extracted under these conditions, it may cause wounds to the vascular tissue, particularly in the xylem and phloem, which could lead to poor healing or even infection. When the pressure is low and sap is being drawn out, the exposed tap holes are more vulnerable to bacteria, fungi, and pathogens entering the tree. The reduced flow may make it harder for the tree to naturally “close” the wound and heal the area, making it susceptible to disease, like sap rot or tree fungus. Moreover, when internal pressure is low, the tree may not be able to produce as much sap, resulting in significantly reduced sap yield. If sap is collected when the tree's vascular pressure is insufficient, the quantity of sap harvested may be smaller, and it may not flow freely. During low-pressure periods, sap may not flow efficiently, and the sap collected could be of lower quality. This might result in a lower yield of sap per tap, and/or a lower concentration of sugars in the sap. Finally, repeated forced sap extraction during low-pressure conditions (like early morning or late in the sap season when pressure is naturally low) can result in a lowered sugar yield per tap over the entire production season.

The extraction of sap regardless of the internal pressure of a tree further presents concerns for the entirety of the sap collection system. For instance, in modern maple syrup operations that use vacuum pumps to help extract sap, low internal pressure (in the tree's vascular system) can lead to inefficient vacuum systems. When the pressure within the tree is low, it can become harder for the vacuum pump to draw sap out effectively, resulting in lower sap yields and possibly even air infiltration issues through the tap and tubing system, potentially leading to frozen tubes.

US Patent Publication No. 2024/0337552, filed on Mar. 28, 2024, in the name of HUARD et al., relates to a pressure sensing device for a sap collection system. In particular, this document describes pressure sensing devices used to monitor pressure values indicative of local pressure within the conduit network so as to detect faults. The pressure sensing devices can be installed at different locations of the conduit network with certain sensors being installed, for instance, proximate distal ends of the auxiliary collection tubes or along the main collection tube. In this manner, the pressure sensing devices are limited to the monitoring of pressure within the conduit network and are thus incapable of sensing the state of the trees.

Despite known improvements over the years, there is therefore a continued need to innovate and find better and/or more efficient ways of extracting sap from trees, for example, and to be able do so in a quicker, simpler, more precise, more efficient, more economical, more reliable, more adjustable, more versatile, more adaptable, more durable, more environmentally conscientious, more desirable, and/or improved manner, than what is possible with the actual way of doing things.

Therefore, it would be particularly useful to be able to provide a sap collection system (and/or associated method) which would be able to overcome or at the very least minimize some of the known drawbacks associated with conventional systems and ways of doing in the field of maple syrup production, for example.

### SUMMARY

In accordance with an aspect there is provided a vacuum control system for a sap collection system having a conduit network coupled to a plurality of trees and a vacuum pump operatively connectable to the conduit network to control a pressure in the conduit network. The vacuum control system may comprise a pressure sensor coupled to a reference tree of the plurality of trees, the pressure sensor being configured to measure a pressure within a vascular system of the reference tree, and a controller communicatively coupled to the pressure sensor and configured to control a vacuum level within the conduit network in response to pressure data received from the pressure sensor.

In certain embodiments, the controller is operatively connected to the vacuum pump to control a flow rate of the vacuum pump to vary the vacuum level in the conduit network of the sap collection system.

In certain embodiments, the controller is configured to operate the vacuum pump at a maximum operating flow rate when the pressure data received from the pressure sensor is above a first pressure threshold.

In certain embodiments, the controller is configured to decrease the operating flow rate of the vacuum pump when the pressure data received from the pressure sensor is below the first pressure threshold to decrease the pressure in the conduit network.

In certain embodiments, the controller is configured to disable an operation of the vacuum pump when the pressure data received from the pressure sensor is below a second pressure threshold.

In certain embodiments, the controller comprises a valve assembly fluidly connected to the conduit network between the vacuum pump and the plurality of trees.

In certain embodiments, the controller is configured to throttle the valve assembly to a fully open position when the pressure data received from the pressure sensor is above a first pressure threshold.

In certain embodiments, the controller is configured to throttle the valve assembly to an at least partially open position when the pressure data is below the first pressure threshold to decrease the pressure in the conduit network.

In certain embodiments, the controller is configured to throttle the valve assembly to a fully closed position when the pressure data received from the pressure sensor is below a second pressure threshold.

In certain embodiments, the first pressure threshold is associated with a positive pressure within the vascular system of the reference tree.

In certain embodiments, the first pressure threshold is definable by a user.

In certain embodiments, the second pressure threshold corresponds to a negative pressure within the vascular system of the reference tree.

In certain embodiments, the vacuum control system further comprises a temperature sensor communicatively coupled to the controller and configured to measure an ambient temperature, the controller being further configured to regulate the operation of the vacuum pump in response to temperature data received from the temperature sensor.

In certain embodiments, the controller is configured to disable an operation of the vacuum pump when the temperature data received from the temperature sensor is below a temperature threshold.

In certain embodiments, the temperature threshold corresponds to a temperature associated with a freezing of sap within the conduit network.

In certain embodiments, the temperature threshold corresponds to a temperature associated with a freezing of sap within the vascular system of the reference tree.

In certain embodiments, the temperature threshold is definable by a user.

In certain embodiments, the pressure sensor comprises a communication module configured to wirelessly transmit the pressure data to the controller.

In certain embodiments, the communication module is a low energy communication module locally broadcasting the pressure data measured by the pressure sensor within a local range.

In certain embodiments, the low energy communication module is a Bluetooth® Low Energy (BLE) communication module.

In certain embodiments, the pressure sensor is a first pressure sensor and the reference tree is a first reference tree, the vacuum control system further comprising a second pressure sensor coupled to a second reference tree, the second pressure sensor being configured to measure a pressure within a vascular system of the second reference tree.

In certain embodiments, the controller is further communicatively coupled to the second pressure sensor and configured to control the flow rate of the vacuum pump in response to pressure data received from the first and second pressure sensors.

In certain embodiments, the conduit network is a first conduit network coupled to a first subset of trees comprising the first reference tree, and wherein the vacuum pump is a first vacuum pump operatively connectable to the first conduit network, the sap collection system further comprising a second conduit network coupled to a second subset of trees comprising the second reference tree, and a second vacuum pump operatively connectable to the second conduit network to control a pressure in the second conduit network.

In certain embodiments, the controller is communicatively coupled to the second pressure sensor and configured to control a flow rate of the second vacuum pump in response to pressure data received from the second pressure sensor to vary a pressure in the second conduit network of the sap collection system.

In certain embodiments, the conduit network is configured to convey sap from trees.

In certain embodiments, the vacuum pump is configured to drive sap from the plurality of trees into a substantially rigid container (ex. made of stainless steel, non-corrosive metallic material, plastic material, composite material, and/or other type of material, etc.) being operatively connected to the conduit network.

According to another aspect, there is provided a method of controlling a pressure within a conduit network of a sap collection system coupled to a plurality of trees. The method can comprise retrieving pressure data from a pressure sensor coupled to a reference tree of the plurality of trees, the pressure data relating to a pressure within a vascular system of the reference tree, and controlling a flow rate of a vacuum pump of the sap collection system in response to the pressure data to vary the pressure in the conduit network.

In certain embodiments, controlling the vacuum pump comprises operating the vacuum pump at a at a maximum operating flow rate when the pressure data received from the pressure sensor is above a first pressure threshold.

In certain embodiments, the method further comprises the step of associating the first pressure threshold with a positive pressure within the vascular system of the reference tree.

In certain embodiments, the method further comprises the step of predefining the first pressure threshold.

In certain embodiments, controlling the vacuum pump comprises decreasing the operating flow rate of the vacuum pump when the pressure data received from the pressure sensor is below the first pressure threshold to decrease the pressure in the conduit network.

In certain embodiments, controlling the vacuum pump comprises disabling an operation of the vacuum pump when the pressure data received from the pressure sensor is below a second pressure threshold.

In certain embodiments, the method further comprises the step of associating the second pressure threshold with a negative pressure within the vascular system of the reference tree.

In certain embodiments, the method further comprises retrieving temperature data from a temperature sensor configured to measure an ambient temperature.

In certain embodiments, controlling the vacuum pump further comprises controlling the flow rate of the vacuum pump in response to the temperature data to vary the pressure in the conduit network.

In certain embodiments, controlling the flow rate of the vacuum pump comprises disabling an operation of the vacuum pump when the temperature data received from the temperature sensor is below a temperature threshold.

In certain embodiments, the method further comprises associating the temperature threshold with a freezing temperature of sap within the conduit network.

In certain embodiments, the method further comprises the step of predefining the temperature threshold.

In certain embodiments, retrieving the pressure data comprises wirelessly retrieving the pressure data via a low energy communication protocol (e.g., Bluetooth® Low Energy (BLE)).

### BRIEF DESCRIPTION OF THE DRAWINGS

FIG. 1 is a schematic representation of a sap collection system including a vacuum control system, in accordance with a possible embodiment.

FIG. 2 is a schematic cross-sectional view of a reference tree illustrating a reference pressure sensor of the sap collector system 10 of FIG. 1 coupled to the reference tree's vascular tissue to measure internal pressure, in accordance with a possible embodiment.

### DETAILED DESCRIPTION

In the following description, the same numerical references refer to similar elements. Furthermore, for sake of simplicity and clarity, namely so as to not unduly burden the figures with several reference numbers, only some figures have been provided with reference numbers, and components and features of the present invention illustrated in other figures can be easily inferred therefrom. The embodiments, geometrical configurations, materials mentioned and/or dimensions shown in the figures are preferred, for exemplification purposes only.

Moreover, although the present system was primarily designed for a sap collection system intended to extract sap from a corresponding tree (for example, a maple tree) intended to be used for syrup production purposes, such as that of maple syrup, for example, the invention may be used with any other type of system and/or for any other type of application and/or useful end, as apparent to a person skilled in the art. For this reason, expressions such as “sensor”, “extract”, “water”, “maple sap”, “syrup”, “sugar”, etc., as used herein, and/or any other reference(s) and/or expression(s) equivalent or similar to these expressions should not be taken so as to limit the scope of the present invention and include any other kind of object/substitute and/or any other application with which the present invention could be used and may be useful, as apparent to a person skilled in the art.

Moreover, in the context of the present invention, expressions such as “system”, “kit”, “device”, “assembly”, “mechanism”, “product”, “apparatus”, “add-on”, “retrofit”, etc., as well as any other equivalent expression(s) and/or compound word(s) thereof, may be used interchangeably in the context of the present description, as apparent to a person skilled in the art. This applies also for any other mutually equivalent expressions, such as: a) “extract”, “withdraw”, “remove”, “reduce”, “take-away”, “seep out”, etc. ; b) “water”, “fluid”, “liquid”, “solution”, “undesirable”, etc. ; c) “drive”, “channel”, “conduit”, “draw”, “pump”, “push”, “pull”, “flow”, “bias”, “differential pressure”, “pressurize”, etc. ; d) “concentrate”, “densify”, “increase”, etc. ; e) “comprise”, “include”, “provide”, “contain”, “dispose”, etc. ; f) “controller”, “command”, “computer”, “circuit”, “hardware”, “software”, “program”, “electric, electronic and computer components”; as well as any other mutually equivalent expressions, related to the aforementioned expressions and/or to any other structural and/or functional aspects of the present invention, as also apparent to a person skilled in the art.

Furthermore, in the context of the present description, it will be considered that all elongated objects will have an implicit “longitudinal axis” or “centerline”, such as the longitudinal axis of an elongated object (ex. pipe, channel, cylinder, coiled membrane, etc.), for example, or the centerline of a coiled spring, for example, and that expressions such as “connected” and “connectable”, or “mounted” and “mountable”, may be interchangeable, in that the present invention also relates to a kit with corresponding components for assembling a resulting fully-assembled and fully-operational vacuum control system.

Moreover, components of the present system(s) and/or steps of the method(s) described herein could be modified, simplified, altered, omitted and/or interchanged, without departing from the scope of the present invention, depending on the particular application(s) which the present invention is intended for, and the desired end result(s), as briefly exemplified herein and as also apparent to a person skilled in the art.

In addition, although the preferred embodiments of the present invention as illustrated in the accompanying drawings comprise various components, and although the preferred embodiments of the present vacuum control system and corresponding portion(s)/part(s)/component(s) (ex. water-extraction assembly, etc.) as shown consist of certain geometrical configurations, as explained and illustrated herein, not all of these components and geometries are essential to the invention and thus should not be taken in their restrictive sense, i.e. should not be taken so as to limit the scope of the present invention. It is to be understood, as also apparent to a person skilled in the art, that other suitable components and cooperation there in between, as well as other suitable geometrical configurations may be used for the present vacuum control system and corresponding portion(s)/part(s)/component(s) according to the present invention, as will be briefly explained herein and as can be easily inferred here from by a person skilled in the art, without departing from the scope of the present invention.

Broadly described, the present system, as illustrated in the accompanying figures, relates to a vacuum control system configured to control a vacuum level within a conduit network in response to pressure data received from a reference pressure sensor. More specifically, the present invention is directed to a system for controlling a flow of sap with a conduit network of a sap collection system in accordance with the natural pressure cycles present inside the trees so as to potentially maximise the extraction of sap therefrom. In this manner, the sap extracted from the trees may be of a higher quality (i.e., contain a higher concentration of sugars) and/or generate a greater volume of sap.

As specified above, the flow of sap from the tree may be affected by the pressure inside a vascular system of the tree. This pressure is caused by temperature variations applied to the tree, by atmospheric pressure conditions as well as a tree's natural exchange of gases through the surface of the tree.

In certain embodiments, the vacuum control system is configured to control the pumping of the sap collection system in accordance with pressure data received from the vascular system of one or more reference trees. In other embodiments, the vacuum control system may be configured to control the pumping of the sap collection system in accordance with multiple additional data sources including for instance atmospheric pressure, ambient temperature, wind direction, wind force, internal temperature of one or more reference trees, bark surface temperature, received sunlight, internal sap level, and/or temperature at one or more tapoholes. In this manner, the vacuum control system can be configured to determine the optimal pumping conditions of the sap collection system including, for instance, whether a vacuum pump of the sap collection system should be on and/or at what flow rate it should operate and/or for what period of time it should operate.

Furthermore, it is worth mentioning that the present invention/technology can not only be commercialized as a resulting vacuum control system per se, but also, via the commercialization and sales of associated component(s) and/or parts thereof only, as well, such as, for example, a controller, an associated pressure sensor, etc.

As can be readily understood from the present specification and the accompanying drawings, the system is particularly advantageous because it aligns vacuum application with the tree's natural pressure cycle. When pressure is high within the tree's vascular system (typically during early-spring thaws as ambient temperatures fluctuate between freezing at night and above-freezing during the day), a natural positive push develops that drives sap outward more efficiently, so sap flows readily and extraction becomes more productive. During this high-pressure portion of the cycle, the sap also tends to exhibit a higher sugar concentration. This results from the internal mobilization of sugars during the spring waking cycle: when internal pressure is low, a natural aspiration draws sap upward from lower portions of the tree, where it mixes with sugars as it moves through the conductive tissues; subsequently, as internal pressure rises, that sugar-enriched sap is pushed outward and upward toward higher branches and, when tapped, outward through the taphole. Extracting sap during the high-pressure phase therefore coincides with a state in which the tree is naturally “ready” to release sap, improving extraction efficiency.

This pressure build-up is part of the tree's normal spring rhythm following freezing nights and warmer days, and timing extraction to these high-pressure windows allows syrup producers to take advantage of the period most favorable to optimal production. By contrast, when internal pressure is low, forcing extraction limits both the quantity of sap that can be mobilized and the height it can reach within the tree, resulting in sap with a lower proportion of mixed sugars and, consequently, diminished yield and quality.

The reading of the following paragraphs, in association with the drawings, will enable to better understand how the advantages having been announced are associated with the technical novelties of the invention.

Broadly, a sap collection system 10 is provided for varying a vacuum level in a sap collection conduit network 12. As used herein, the expression “vacuum level” refers to the absolute pressure within a closed sap conduit network relative to atmospheric pressure, such that a lower absolute pressure corresponds to a higher vacuum. The sap collection system 10 includes a vacuum control system 100 configured to respond to real-time pressure measured within the vascular system of a reference tree 6 to modulate a vacuum pump 14 and/or a valve assembly 18 to vary the vacuum level in the sap collection conduit network 12. When the reference tree 6 indicates a positive vascular pressure (e.g., during a thaw), the system increases or maintains vacuum to promote sap flow, as described in greater detail below. When the reference tree 6 indicates reduced or negative vascular pressure (e.g., during a freeze), the system decreases or disables vacuum to reduce energy consumption, prevent damage, and avoid drawing air through leaks. In accordance with another embodiment, ambient temperature may be measured and used to inhibit or modify vacuum operation when temperatures indicate sap freezing in the conduit network or in the tree. As used herein, the expression “reference tree” is intended to refer a selected tree whose vascular pressure is sensed and used as a control input representative of a broader stand or zone, as described in greater detail below.

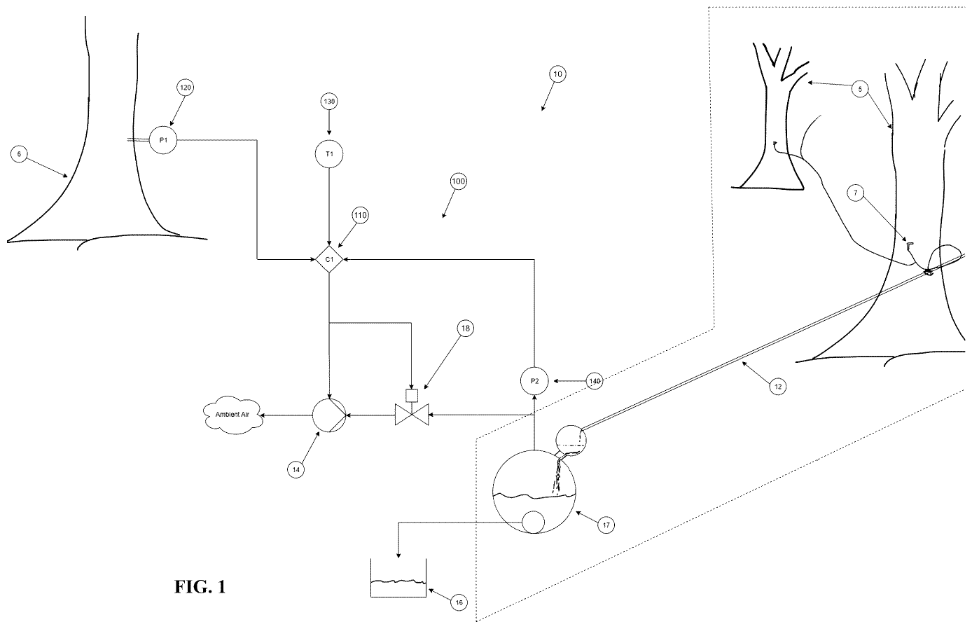

Referring now to FIG. 1, a sap collection system 10 is illustrated in accordance with an embodiment. The sap collection system 10 includes a closed conduit network 12 coupled to a plurality of trees 5 and a vacuum pump 14 operatively connectable to the conduit network 12 to regulate pressure within the network. A reference tree 6 is equipped with a pressure sensor 120 that is coupled to the vascular system of the reference tree 6. As used herein, the expression “vascular system” refers to the conductive tissues of a tree, such as xylem. The reference pressure sensor 120 can be configured to measure a pressure within the vascular system. In certain embodiments, a controller 110 is communicatively coupled to the reference pressure sensor 120 and is configured to control the vacuum level within the conduit network 12 in response to pressure data received from the reference pressure sensor 120, as described in greater detail below. In representative embodiments, the controller 110 is operatively connected to the vacuum pump 14 to control a flow rate of the vacuum pump 14 to vary the vacuum level in the conduit network 12. The controller 110 may additionally or alternatively drive a valve assembly 18 fluidly connected to the conduit network 12 between the vacuum pump 14 and the plurality of trees 5, whereby the controller 110 may throttle the valve assembly 18 to modulate the vacuum level within the conduit network 12.

In typical installations, the conduit network 12 includes laterals from individual taps at trees 5, one or more manifolds, and one or more mainlines leading to a reservoir 16. The reservoir 16 may be a substantially rigid container configured to receive sap under vacuum and may be fabricated from stainless steel, other non-corrosive metallic materials, plastic materials, composite materials, or combinations thereof, sized and fitted for sanitary operation under vacuum conditions. The vacuum pump 14 is operatively connectable to the conduit network 12 to draw sap from the trees 5 through the conduit network 12 into the reservoir 16, and can be implemented as a variable-speed pump, a multi-stage pump, or a pump controlled by duty cycle. In some embodiments, a conduit pressure sensor 140 may be disposed in fluid communication with the conduit network 12 to measure a pressure within the sap collector system 10, thereby providing additional feedback indicative of line vacuum and enabling verification or supervisory control of the vacuum level within the conduit network 12.

In certain embodiments, the sap collection system 10 may further include an intermediate vessel 17 positioned between the vacuum side of the conduit network 12 and the reservoir 16. The intermediate vessel 17 may be configured to collect sap under vacuum and intermittently transfer it to the reservoir 16 while preserving vacuum in the conduit network 12, isolating the vacuum pump 14 from liquid carryover, and facilitating controlled metering and transfer operations. In some embodiments, the intermediate vessel 17 may function as an air-liquid separator, allowing entrained air to disengage from incoming sap so that the separated air is exhausted on the vacuum side while the degassed sap is periodically discharged to the reservoir 16, thereby potentially preserving vacuum integrity in the conduit network 12 and protecting the vacuum pump 14.

As described above, the reference pressure sensor 120 is configured to measure a pressure within the vascular system of the reference tree 6, such as within xylem tissue, using a sealed interface that fluidly couples the reference pressure sensor 120 to the vascular system while minimizing sap loss. The reference pressure sensor 120 is configured to resolve both positive and negative pressures relative to atmospheric pressure and to operate outdoors in the environmental conditions typical of sap collection seasons. The reference pressure sensor 120 can include on-board signal conditioning and a communication module configured to transmit pressure data to the controller 110. In some embodiments the communication module is a low-energy communication module locally broadcasting the pressure data measured by the reference pressure sensor 120 within a local range. For instance, in certain embodiments, the communication module may be an RF communication module or a Bluetooth® Low Energy (BLE) communication module. In certain embodiments, the reference pressure sensor 120 may be battery-powered with low-duty operation for energy conservation while maintaining sufficient temporal resolution to inform control actions by the controller 110.

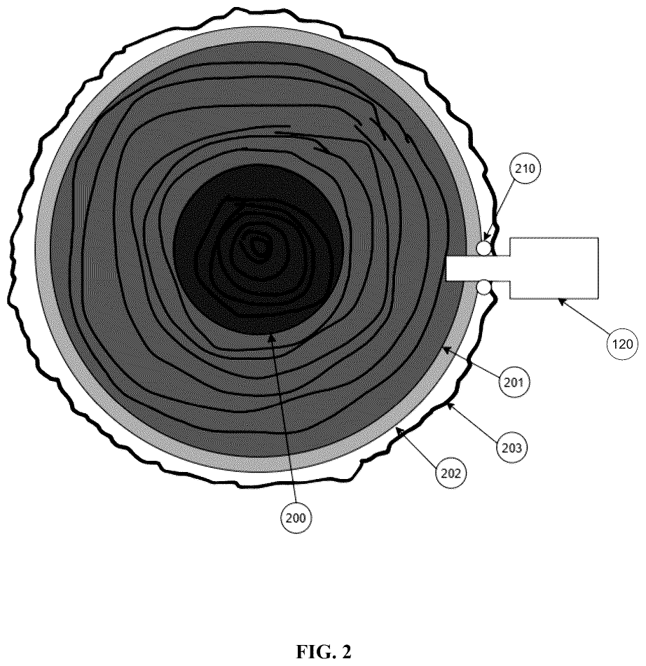

FIG. 2 illustrates an exemplary installation of the reference pressure sensor 120 within a taphole formed in the reference tree 6, showing a cross-section through the trunk in which the core 200, the xylem (sapwood) 201, the current-year living layer 202, and the bark 203 are identified. In this embodiment, a radial bore is made through the bark 203 and living layer 202 and into the xylem 201 to a depth sufficient to place a sensing port of the reference pressure sensor 120 within hydraulically active xylem tissue 201 while avoiding unnecessary penetration into the core 200, thereby enabling accurate measurement of vascular pressure. The reference pressure sensor 120 is inserted into the taphole and sealed in place by a sealing medium 210 to establish an airtight interface around the sensor body and at the wood-sensor interface. In certain embodiments, the sealing medium 210 may be a food-grade grease applied circumferentially, an elastomeric element such as a rubber grommet, or an O-ring (e.g., silicone or other suitable elastomer) captured in a groove of the sensor housing. It will be understood that the sealing medium 210 may prevent ambient air ingress and bulk sap leakage around the sensor, stabilize the pressure coupling between the xylem 201 and the transducer inlet, and maintain the seal through freeze-thaw cycling. The taphole can be oriented and sized to receive the reference pressure sensor 120 without inducing excess compression of the living layer 202, and the sensor may be installed against a positive stop or using a depth indicator to ensure consistent placement within the xylem 201.

In certain embodiments, the reference tree 6 does not form part of the plurality of trees 5 and is not connected to the conduit network 12 for sap extraction; instead, the reference tree 6 is instrumented solely for pressure measurement so that no sap is conveyed from the reference tree 6 into the sap collector system 10. In such embodiments, the interface to the vascular system is isolated from the conduit network 12, thereby ensuring that measurements of the reference pressure sensor 120 reflect the intrinsic physiological pressure state of the reference tree 6 without perturbation by vacuum applied by the vacuum pump 14 or by transient conditions within the conduit network 12, and further ensuring that the reference tree 6 is preserved for measurement purposes independent of sap removal operations performed on the trees 5.

In certain embodiments, the controller 110 may be configured to receive pressure data from the reference pressure sensor 120 associated with the reference tree 6 and regulate operation of the vacuum pump 14 and/or throttling of the valve assembly 18 to vary the vacuum level in the conduit network 12. In one embodiment, when the pressure data received from the reference pressure sensor 120 is above a first pressure threshold associated with a given positive pressure within the vascular system of the reference tree 6, the controller 110 may operate the vacuum pump 14 at a maximum operating flow rate. When the pressure data received from the reference pressure sensor 120 is below the first pressure threshold, the controller 110 decreases the operating flow rate of the vacuum pump 14 to decrease the pressure in the conduit network 12. When the pressure data received from the reference pressure sensor 120 is below a second pressure threshold corresponding to a given negative pressure within the vascular system of the reference tree 6, the controller 110 disables an operation of the vacuum pump 14. In certain embodiments, the first pressure threshold and the second pressure threshold may be predefined. In other embodiments, the first pressure threshold and the second pressure threshold may be definable by a user via a local or remote interface to the controller 110. In certain embodiments, hysteresis bands around the thresholds and minimum on/off times can be implemented by the controller 110 to prevent rapid cycling of the vacuum pump 14 and to stabilize vacuum levels within the conduit network 12.

As stated above, in certain embodiments, the controller 110 may be configured to command the valve assembly 18 disposed fluidly between the vacuum pump 14 and the plurality of trees 5 to regulate the hydraulic communication between the vacuum pump 14 and the conduit network 12 in response to pressure data from the reference pressure sensor 120. When the pressure data received from the reference pressure sensor 120 is above the first pressure threshold, the controller 110 may throttle the valve assembly 18 to a fully open position, minimizing flow restriction so that the vacuum generated by the vacuum pump 14 is substantially communicated to the conduit network 12 with minimal pressure drop, thereby promoting a high sap throughput toward the reservoir 16. When the pressure data received from the reference pressure sensor 120 is below the first pressure threshold, the controller 110 may throttle the valve assembly 18 to an at least partially open position, introducing a deliberate restriction that creates a controllable pressure differential across the valve assembly 18. This may moderate the vacuum transmitted to the conduit network 12 and shape the pressure profile within the conduit network 12 to decrease the pressure in the conduit network 12 toward a target range. When the pressure data received from the reference pressure sensor 120 is below the second pressure threshold, the controller 110 may throttle the valve assembly 18 to a fully closed position, fluidly isolating the conduit network 12 from the vacuum pump 14 and arresting flow within the conduit network 12 to protect the sap collector system 10 under negative vascular pressure states or freezing conditions. In this state the controller 110 may optionally disable operation of the vacuum pump 14. In each commanded position, the controller 110 can apply ramped actuation, hysteresis, and minimum dwell times to avoid rapid cycling and to manage the dynamic response of the conduit network 12.

In certain embodiments, the valve assembly 18 may be installed and configured to admit a metered quantity of atmospheric air into the vacuum side of the conduit network 12, thereby deliberately lowering the vacuum level in the conduit network 12 and/or reducing the vacuum applied to the intermediate vessel 17.

In certain embodiments, the vacuum control system 100 may further include a temperature sensor 130 communicatively coupled to the controller 110 and configured to measure an ambient temperature proximate the conduit network 12 or the reference tree 6. The controller 110 may be configured to regulate operation of the vacuum pump 14 in response to temperature data received from the temperature sensor 130. In some embodiments, when the temperature data received from the temperature sensor 130 is below a temperature threshold, the controller 110 may disable an operation of the vacuum pump 14. The temperature threshold may correspond to a temperature associated with a freezing of sap within the conduit network 12 and/or to a temperature associated with a freezing of sap within the vascular system of the reference tree 6. The temperature threshold can be predefined and, in certain implementations, is definable by a user. The controller 110 can also implement a hold-off time such that operation resumes only after the ambient temperature measured by the temperature sensor 130 has remained above the temperature threshold for a defined period to ensure thaw conditions before re-enabling normal control based on the pressure data from the reference pressure sensor 120.

The vacuum control system 100 leverages an understanding of sap removal from trees 5 under both natural and induced pressure gradients. During thaw periods, gas expansion and osmotic effects within the vascular system of the reference tree 6 can produce a positive pressure within xylem that drives sap toward a taphole under natural conditions; applying vacuum via the vacuum pump 14 to the conduit network 12 lowers pressure downstream of the taphole and increases the pressure differential across the wound interface, thereby increasing sap yield from the trees 5. During cooling or freeze events, contraction of gases within above-ground tissues of the trees 5 and phase change of sap can result in reduced or negative pressure within the vascular system of the reference tree 6. Continuing to apply high vacuum under such conditions is energetically inefficient and can promote air ingress through micro-leaks or even draw gases through tissues with limited sap movement. By referencing the pressure measured by the reference pressure sensor 120 at the reference tree 6 and optionally ambient temperature measured by the temperature sensor 130, the controller 110 aligns operation of the vacuum pump 14 and the valve assembly 18 with the physiological sap flow potential of the stand, improving yield opportunity when sap is mobile while reducing energy consumption and protecting the sap collector system 10 when sap flow is limited. In addition, modulating vacuum levels to avoid over-evacuation when sap flow is limited can reduce desiccation risk at the taphole, limit collapse of soft conduit segments under deep vacuum, and mitigate the propagation of leaks within the conduit network 12 by reducing driving forces when such leaks provide no flow benefit.

In an expanded configuration, the vacuum control system 100 may include a first reference pressure sensor 120 coupled to a first reference tree 6 and a second reference pressure sensor coupled to a second reference tree 6. The controller 110 is further communicatively coupled to the second reference pressure sensor and is configured to control the flow rate of the vacuum pump 14 in response to pressure data received from the first reference pressure sensor 120 and the second reference pressure sensor. In a multi-network configuration, the first conduit network 12 is coupled to a first subset of trees 5 including the first reference tree 6 and is served by the first vacuum pump 14, while a second conduit network is coupled to a second subset of trees 5 including the second reference tree 6 and is served by a second vacuum pump. In such embodiments, the controller 110 may also be communicatively coupled to the second reference pressure sensor and configured to control a flow rate of the second vacuum pump in response to pressure data received from the second reference pressure sensor to vary a pressure in the second conduit network, with each network operating according to its own first pressure threshold and second pressure threshold and optionally its own temperature threshold from a corresponding temperature sensor 130. In such embodiments, the controller 110 can be implemented as a single device that manages multiple zones or as multiple coordinated controllers that share data while executing independent control actions for each conduit network.

In certain embodiments, the conduit pressure sensor 140 located in the conduit network 12 can be used by the controller 110 to corroborate vacuum levels commanded by the vacuum pump 14 and to detect abnormal conditions such as leaks, blockages, or frozen segments within the conduit network 12. The controller 110 may use the pressure data from the pressure sensor 140 as a supervisory input without displacing the primary control based on the pressure data from the reference pressure sensor 120 at the reference tree 6. For example, if the reference pressure sensor 120 indicates a positive pressure condition at the reference tree 6 but the conduit pressure sensor 140 indicates that the vacuum level within the conduit network 12 is not responding to increased operation of the vacuum pump 14, the controller 110 can trigger diagnostics or a failsafe condition, as described in greater detail below.

Accord to another aspect, there is also provided a method of controlling a pressure within a conduit network of a sap collection system coupled to a plurality of trees. The method associated with the vacuum control system 100 may include retrieving pressure data from the reference pressure sensor 120 coupled to the reference tree 6, the pressure data relating to a pressure within the vascular system of the reference tree 6, and subsequently controlling a flow rate of the vacuum pump 14 of the sap collector system 10 in response to the pressure data to vary the pressure in the conduit network 12.

In certain embodiments, the method can further include operating the vacuum pump 14 at a maximum operating flow rate when the pressure data received from the reference pressure sensor 120 is above the first pressure threshold, decreasing the operating flow rate of the vacuum pump 14 when the pressure data received from the reference pressure sensor 120 is below the first pressure threshold to decrease the pressure in the conduit network 12, and disabling an operation of the vacuum pump 14 when the pressure data received from the reference pressure sensor 120 is below the second pressure threshold. The method can include associating the first pressure threshold with a positive pressure within the vascular system of the reference tree 6 and associating the second pressure threshold with a negative pressure within the vascular system of the reference tree 6, and predefining one or both of the first pressure threshold and the second pressure threshold. In wireless implementations, retrieving the pressure data may include wirelessly retrieving the pressure data via a low-energy communication protocol, such as Bluetooth® Low Energy, from the reference pressure sensor 120 to the controller 110.

In certain embodiments, the method may further include retrieving temperature data from the temperature sensor 130 configured to measure an ambient temperature and controlling the flow rate of the vacuum pump 14 in response to the temperature data to vary the pressure in the conduit network 12, including disabling an operation of the vacuum pump 14 when the temperature data received from the temperature sensor 130 is below a temperature threshold associated with a freezing of sap within the conduit network 12 and/or within the vascular system of the reference tree 6, and predefining the temperature threshold.

Installation and configuration of the vacuum control system 100 can include mounting the reference pressure sensor 120 to the reference tree 6 using a sealed interface to the vascular system, zeroing the reference pressure sensor 120 to ambient pressure, validating linearity and range, and storing the first pressure threshold, the second pressure threshold, and the temperature threshold in memory accessible to the controller 110. The controller 110 can also store communication parameters for the reference pressure sensor 120 and the temperature sensor 130, including broadcast intervals and sampling rates appropriate for outdoor conditions and the dynamics of sap movement. In certain embodiments, the controller 110 can implement diagnostic checks for stale data, out-of-range values, or communication loss with the reference pressure sensor 120, the pressure sensor 140, or the temperature sensor 130, and when such a fault is detected, the controller 110 can enter a failsafe state. The controller 110 can incorporate smoothing filters to suppress noise in the pressure data, incorporate hysteresis around the first pressure threshold and the second pressure threshold, and enforce ramp rates on changes to the flow rate of the vacuum pump 14 or the position of the valve assembly 18 to avoid pressure shocks in the conduit network 12.

As stated above, upon detection of a failsafe condition (such as, for example, out-of-range data from the reference pressure sensor 120, loss of communication with the reference pressure sensor 120, a conflicting indication between the pressure sensor 120 and the conduit-side pressure sensor 140, or other diagnostics executed by the controller 110), the controller 110 may transition the sap collector system 10 to a failsafe state. For instance, in one embodiment, the controller 110 may disable operation of the vacuum pump 14 and command the valve assembly 18 to a fully closed position to fluidly isolate the conduit network 12 until valid data is restored, thereby protecting equipment and preventing unintended air ingress or liquid carryover. Alternatively, in other embodiments intended to mitigate the economic impact of a shutdown, the controller 110, when entering the failsafe state, may command the valve assembly 18 to a fully open configuration and maintain the vacuum pump 14 thereby preserving a stable level of vacuum in the conduit network 12 and continuing to draw sap from trees 5 that are capable of yielding sap even when the reference tree 6 may not be in a positive pressure state. This approach allows collection to proceed at reduced efficiency rather than ceasing entirely, which can be economically preferable to a complete shutdown. In such embodiments, the controller 110 may record the fault and optionally limit operating parameters to conservative values.

It will be understood that the foregoing systems and methods can be implemented without departing from the scope of the vacuum control system 100 by varying the location of the controller 110 relative to the vacuum pump 14 and the conduit network 12, by implementing wired or wireless links between the controller 110 and the reference pressure sensor 120, the pressure sensor 140, and the temperature sensor 130, by selecting materials for the reservoir 16 and the conduit network 12 suited to sanitary vacuum service, and by scaling the architecture to manage multiple zones corresponding to microclimates within a stand of trees 5. Features described in connection with any embodiment can be combined with features of any other embodiment unless stated otherwise, and steps recited in the method associated with the vacuum control system 100 can be performed in different orders or concurrently where appropriate to the implementation.

Finally, it will be appreciated that the present invention may be used in other agricultural environments, such as animal husbandry or livestock farming, in which vacuum systems may be used in accordance with tubing system adapted to convey, for instance, milk from animals to reservoirs or for cleaning/washing purposes.

Although the present invention has been previously explained by way of preferred embodiments, it is to be understood that any modification to these preferred embodiments is not considered changing nor altering the nature and the scope of the present invention. Indeed, the scope of the enclosed claim(s) should not be limited by the preferred embodiments set forth in the examples, but should be given the broadest interpretation consistent with the description as a whole.

1. A vacuum control system for a sap collection system having a conduit network coupled to a plurality of trees and a vacuum pump operatively connectable to the conduit network to control a pressure in the conduit network, the vacuum control system comprising:
a reference pressure sensor coupled to a reference tree, the reference pressure sensor being configured to measure a pressure within a vascular system of the reference tree; and
a controller communicatively coupled to the reference pressure sensor and configured to control a vacuum level within the conduit network in response to pressure data received from the reference pressure sensor.

2. The vacuum control system according to claim 1, wherein the controller is operatively connected to the vacuum pump to control a flow rate of the vacuum pump to vary the vacuum level in the conduit network of the sap collection system, the controller being configured to operate the vacuum pump at a maximum operating flow rate when the pressure data received from the reference pressure sensor is above a first pressure threshold.

3. The vacuum control system according to claim 2, wherein the controller is configured to decrease the operating flow rate of the vacuum pump when the pressure data received from the reference pressure sensor is below the first pressure threshold to decrease the pressure in the conduit network, and further configured to disable an operation of the vacuum pump when the pressure data received from the reference pressure sensor is below a second pressure threshold.

4. The vacuum control system according to claim 1, further comprising a valve assembly fluidly connected to the conduit network between the vacuum pump and the plurality of trees, the controller being configured to throttle the valve assembly to a fully open position when the pressure data received from the reference pressure sensor is above a first pressure threshold.

5. The vacuum control system according to claim 4, wherein the controller is configured to throttle the valve assembly to an at least partially open position when the pressure data is below the first pressure threshold to decrease the pressure in the conduit network, and further configured to throttle the valve assembly to a fully closed position when the pressure data received from the reference pressure sensor is below a second pressure threshold.

6. The vacuum control system according to claim 2, wherein the first pressure threshold is associated with a positive pressure within the vascular system of the reference tree.

7. The vacuum control system according to claim 1, further comprising a temperature sensor communicatively coupled to the controller and configured to measure an ambient temperature, the controller being further configured to regulate the operation of the vacuum pump in response to temperature data received from the temperature sensor.

8. The vacuum control system according to claim 7, wherein the controller is configured to disable an operation of the vacuum pump when the temperature data received from the temperature sensor is below a temperature threshold.

9. The vacuum control system according to claim 8, wherein the temperature threshold corresponds to at least one of a temperature associated with a freezing of sap within the conduit network, and a temperature associated with a freezing of sap within the vascular system of the reference tree.

10. The vacuum control system according to claim 1, wherein the reference pressure sensor comprises a communication module configured to wirelessly transmit the pressure data to the controller.

11. The vacuum control system according to claim 1, wherein the reference pressure sensor is a first reference pressure sensor and the reference tree is a first reference tree, the vacuum control system further comprising a second reference pressure sensor coupled to a second reference tree, the second reference pressure sensor being configured to measure a pressure within a vascular system of the second reference tree, the controller being further communicatively coupled to the second reference pressure sensor and configured to control the flow rate of the vacuum pump in response to pressure data received from the first and second reference pressure sensors.

12. The vacuum control system according to claim 11, wherein the conduit network is a first conduit network coupled to a first subset of trees comprising the first reference tree, and wherein the vacuum pump is a first vacuum pump operatively connectable to the first conduit network, the sap collection system further comprising a second conduit network coupled to a second subset of trees comprising the second reference tree, and a second vacuum pump operatively connectable to the second conduit network to control a pressure in the second conduit network, the controller being communicatively coupled to the second reference pressure sensor and configured to control a flow rate of the second vacuum pump in response to pressure data received from the second reference pressure sensor to vary a pressure in the second conduit network of the sap collection system.

13. The vacuum control system according to claim 1, wherein the reference tree is not included in the plurality of trees.

14. A method of controlling a pressure within a conduit network of a sap collection system coupled to a plurality of trees, the method comprising:
retrieving pressure data from a reference pressure sensor coupled to a reference tree, the pressure data relating to a pressure within a vascular system of the reference tree;
controlling a flow rate of a vacuum pump of the sap collection system in response to the pressure data to vary the pressure in the conduit network.

15. The method according to claim 14, further comprising the step of associating a first pressure threshold with a positive pressure within the vascular system of the reference tree, and wherein controlling the vacuum pump comprises operating the vacuum pump at a at a maximum operating flow rate when the pressure data received from the reference pressure sensor is above the first pressure threshold.

16. The method according to claim 15, wherein controlling the vacuum pump further comprises decreasing the operating flow rate of the vacuum pump when the pressure data received from the reference pressure sensor is below the first pressure threshold to decrease the pressure in the conduit network.

17. The method according to claim 15, further comprising the step of associating a second pressure threshold with a negative pressure within the vascular system of the reference tree, and wherein controlling the vacuum pump comprises disabling an operation of the vacuum pump when the pressure data received from the reference pressure sensor is below the second pressure threshold.

18. The method according to claim 14, further comprising retrieving temperature data from a temperature sensor configured to measure an ambient temperature, and wherein controlling the vacuum pump further comprises controlling the flow rate of the vacuum pump in response to the temperature data to vary the pressure in the conduit network.

19. The method according to claim 18, further comprising associating the temperature threshold with a freezing temperature of sap within the conduit network.

20. The method according to claim 18, further comprising the step of predefining the temperature threshold.
